(19) United States
(12) Patent Application Publication
(10) Pub. No.: US 2006/0238531 A1
(43) Pub. Date: Oct. 26, 2006

(54) Method of Controlling Screen Brightness of an Electronic Device

(76) Inventor: Tsung-Jung Wang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/160,255

(22) Filed: Jun. 16, 2005

(30) Foreign Application Priority Data
Apr. 25, 2005 (TW) 094113121

(51) Int. Cl. G09G 5/00

(52) U.S. Cl. 345/211

(57) ABSTRACT

A method of controlling screen brightness of an electronic device includes detecting the remaining capacity of a battery installed on an electronic device, and controlling screen brightness of the electronic device according to the remaining capacity of the battery. Power consumption of the electronic device can be reduced according to the remaining capacity of the battery; therefore, battery run time of the electronic device can be increased.

### BACKGROUND OF THE INVENTION

1. Field of the Invention

The present invention relates to a method of controlling screen brightness of an electronic device, more particularly, a method of controlling screen brightness of an electronic device according to a status of a battery.

2. Description of the Prior Art

In modern information society, portable electronic devices such as a notebook computer, personal data assistant (PDA), mobile phone and tablet personal computer have been widely utilized by users from all kinds of industries. With characteristics such as compact size, lightweight design and easy to carry portability, the above-mentioned electronic devices provide the users with the convenience of working mobility. The users are not restricted to only a single location due to characteristics of their electronic devices. Take a slim, lightweight and portable notebook computer as an example, the notebook computer allows the user to have access to calculation and document processing anytime and anywhere. Furthermore, the notebook computer is not restricted in the way that a fixed-in-place, large and bulky desktop computer is restricted. Especially in recent years, as processing speeds of computers and the development of multi-media processing technology has increased tremendously, applications are no longer limited to only document processing. A typical user can perform functions utilizing the notebook computer such as broadcasting and manipulating images and sounds through a powerful operation ability to provide convenience for the user's work or personal pleasure.

There are two types of power supply of the notebook computer: alternating current (AC) power supply and direct current (DC) power supply. AC power supply is from a regular electrical socket. The DC power supply is from a battery. As the capacity of the battery is limited, therefore when the notebook computer is operating on battery power, the notebook computer can usually be utilized for only a few hours. In order to extend utilization time of the notebook computer when the notebook computer is running on battery power, the conventional notebook computer will detect the type of power supply and when the type of power supply detected is DC power supply, for example when a plug of the notebook computer is pulled out of the electrical socket and the notebook computer is required to run on battery power, the notebook computer will automatically reduce screen brightness to reduce power consumption of the battery.

The notebook computer utilizes a basic input/output system (BIOS) to detect the type of power supply of the notebook computer. When the BIOS detects the AC power supply, the BIOS will control the screen brightness of the notebook computer according to a predetermined screen brightness value. When the BIOS detects the type of power supply of the notebook computer to be DC power supply, this means that the notebook computer is now operating on power from the battery, the BIOS will adjust the screen brightness of the notebook computer according to another predetermined screen brightness value. Under normal settings, as the predetermined screen brightness value of the AC power supply is higher than the predetermined screen brightness value of the DC power supply, therefore when the DC power supply is detected, the BIOS will automatically reduce the screen brightness of the notebook computer.

However, when the notebook computer utilizes power from the battery there are situations when the user will not desire that the screen brightness of the notebook computer be automatically reduced. For example, when a user is presenting a short report in a meeting. At this time during the presentation, if the notebook computer were to automatically reduce the screen brightness the result may be that the user is unable to read information shown on a monitor because the screen brightness has become dimmer. This causes unnecessary inconvenience for the user. The user can access certain system settings to turn this function off, but in this way, power consumption will increase because the screen dimming function has been disabled. The conventional method of controlling the screen brightness to reduce power consumption of the battery, according to utilization status, is unable to satisfy the needs of the user.

### SUMMARY OF THE INVENTION

Therefore, a main objective of the claimed invention is to provide a method of controlling screen brightness of an electronic device according to a status of a battery to solve the problem in the above-mentioned.

A method of controlling screen brightness of an electronic device comprising detecting remaining capacity of a battery installed on an electronic device, and controlling screen brightness of the electronic device according to remaining capacity of the battery.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a functional block diagram of a notebook computer according to the present invention.

FIG. 2 illustrates a flowchart of a method of controlling screen brightness according to a status of a battery.

### DETAILED DESCRIPTION

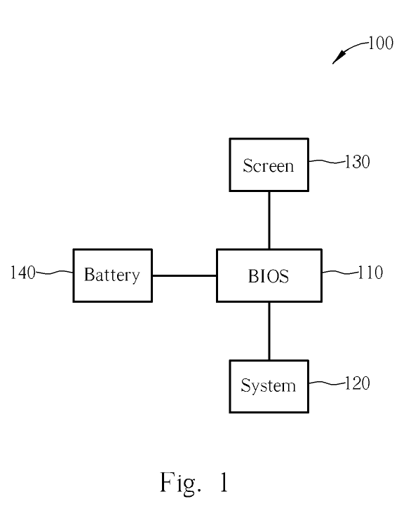

Please refer to FIG. 1. FIG. 1 illustrates a functional block diagram of a notebook computer 100 according to the present invention. Firstly, a basic input/output system (BIOS) 110 will detect the type of power supply of the notebook computer 100. When the BIOS 110 detects the power supply of the notebook computer 100 to be an alternating current (AC) power supply, a system 120 of the notebook computer 100 will control screen brightness 130 of the notebook computer 100 according to a predetermined screen brightness value. For example, the system 120 notifies the BIOS 110 to control the screen brightness 130 of the notebook computer 100. However, when the BIOS 110 detects the power supply of the notebook computer 100 to be a direct current (DC) power supply it means that the notebook computer 100 runs on power from a battery 140, therefore the BIOS 110 will further detect the remaining capacity of the battery 140, when the remaining capacity of the battery 140 is higher than a predetermined value, for example, if the remaining capacity of the battery 140 is higher than 60%, then the system 120 of the notebook computer 100 will not change the screen brightness 130 of the notebook computer 100 and will be maintained as if the screen brightness 130 of notebook computer 100 is running on AC power supply. And when the remaining capacity of the battery 140 is lower than the above-mentioned predetermined value, for example, if the remaining capacity of the battery 140 is lower than 60%, then the system 120 of the notebook computer 100 will reduce the screen brightness 130 of the notebook computer 100 according to the other predetermined screen brightness value, for example, the system 120 will notify the BIOS 110 to reduce the screen brightness 130 of the notebook computer 100 to reduce power consumption of the battery 140.

In addition, the system 120 of the notebook computer 100 is capable of generating remaining utilization time of the battery 140 according to the remaining capacity of the battery 140, and controlling the screen brightness 130 of the notebook computer 100 according to the remaining utilization time of the battery 140. For example, when the BIOS 110 detects the remaining capacity of the battery 140, the system 120 of the notebook computer 100 can generate the remaining utilization time of the battery 140 according to the utilization status of the notebook computer 100 and the remaining capacity of the battery 140, when the remaining utilization time of the battery 140 is longer than a predetermined time, for example, when the remaining utilization time of the battery 140 is longer than one hour, then the system 120 of the notebook computer 100 will not change the screen brightness 130 of the notebook computer 100 and will be maintained as if the screen brightness 130 of notebook computer 100 is running on AC power supply. And when the remaining utilization time of the battery 140 is less than the above-mentioned predetermined time, for example, if the remaining utilization time of the battery 140 is less than one hour, then the system 120 of the notebook computer 100 will reduce the screen brightness 130 of the notebook computer 100 according to a predetermined screen brightness value, for example, the system 120 will notify the BIOS 110 to reduce the screen brightness 130 of the notebook computer 100 to reduce power consumption of the battery 140.

Furthermore, the system 120 of the notebook computer 100 is capable of generating a screen brightness value in different levels according to the remaining capacity of the battery 140 and controlling the screen brightness 130 of the notebook computer 100 according to the screen brightness value generated. For example, the present invention is capable of separating the remaining capacity of the battery 140 into 2 levels. When the remaining capacity of the battery 140 is higher than a first predetermined value, for example, if the remaining capacity of the battery 140 is higher than 60%, then the system 120 of the notebook computer 100 will not change the screen brightness 130 of the notebook computer 100 and will be maintained as if the screen brightness 130 of notebook computer 100 is running on AC power supply. And when the remaining capacity of the battery 140 is lower than the first predetermined value and higher than a second predetermined value, for example if the remaining capacity of the battery 140 is in between 30% to 60%, then the system 120 of the notebook computer 100 will generate a first screen brightness value according to the remaining capacity of the battery, and will reduce the screen brightness 130 of the notebook computer 100 according to the first screen brightness value, for example the system 120 will notify the BIOS 110 to reduce the screen brightness 130 of the notebook computer 100 to reduce power consumption of the battery 140. And when the remaining capacity of the battery 140 is lower than the second predetermined value, for example if the remaining capacity of the battery 140 is lower than 30%, the system 120 of the notebook computer 100 will generate a second screen brightness value according to the remaining capacity of the battery, and the screen brightness 130 of the notebook computer 100 is further reduced according to the second screen brightness, for example the system 120 will notify the BIOS 110 again to reduce the screen brightness 130 of the notebook computer 100 to reduce power consumption of the battery 140. However, in the above-mentioned method is capable of not only controlling the screen brightness 130 of the notebook computer 100 in different levels according to the remaining capacity of the battery 140 and also generating the remaining utilization time of the battery 140 or controlling the screen brightness 130 of the notebook computer 100 in different levels according to other status of the battery 140.

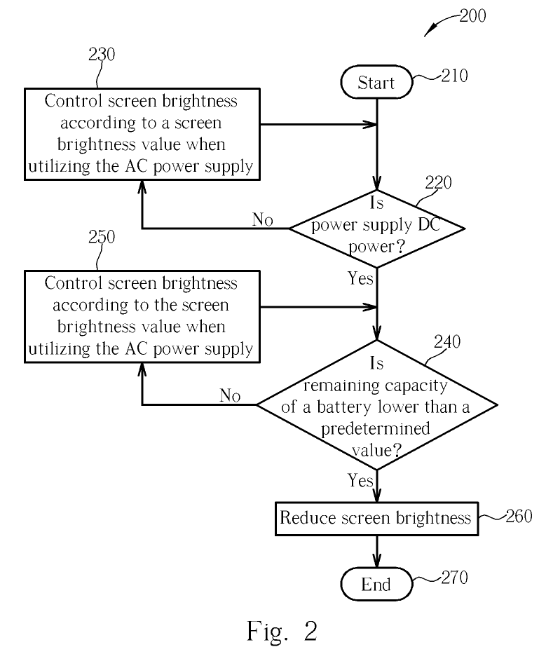

The steps below further explain the method of controlling the screen brightness 130 of the notebook computer 100 according the status of the battery 140. FIG. 2 illustrates a flowchart 200 of the present invention. Please refer to FIG. 2 and at the same time refer to FIG. 1. FIG. 2 comprising the following steps:

Step 210: Start;

Step 220: Determine type of power supply of a notebook computer 100, if AC power supply is detected, go to step 230, if DC power is supply detected, go to step 240;

Step 230: Control screen brightness 130 of the notebook computer 100 according to a screen brightness value when utilizing the AC power supply, go to step 220;

Step 240: Detect whether remaining capacity of a battery 140 of the notebook computer 100 is lower than a predetermined value, if yes, go to step 260, if not, go to step 250;

Step 250: Control screen brightness 130 of the notebook computer 100 according to the screen brightness value when utilizing the AC power supply, and go to step 240;

Step 260: Generate a corresponding screen brightness value, and reduce screen brightness 130 of the notebook computer 100 according to the screen brightness value generated;

Step 270: End.

In achieving the result of the above-mentioned, steps in the flowchart 200 do not have to follow sequentially to the above-mentioned, and each step does not have to be adjacent to one another, other steps can be inserted in between the above-mentioned steps. Furthermore, the present invention is also capable of repeating the steps in the above-mentioned in a periodic basis to determine the utilization status of the notebook computer 100. The present invention is also capable of utilizing a firmware, software or hardware, or any three combinations to achieve the result of the above-mentioned. It is even possible for the system 120 to utilize firmware to write-in the BIOS 110 to execute the method of the present invention. Also, the present invention is utilized not only with the notebook computer 100 but also other electronic devices, such as a personal data assistant or mobile phones. If the electronic device follows the method of the present invention and it is still within the claims of the present invention.

In comparison to the prior art, the present invention provides a method of controlling screen brightness of an electronic device according to a status of a battery to reduce power consumption of the battery. The present invention controls the screen brightness of the electronic device according remaining capacity of the battery, therefore when a user temporarily utilizes power from the battery, the electronic device will not reduce the screen brightness, as there is a power supply change. Hence, the present invention increases utilization flexibility to satisfy the user's needs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of controlling screen brightness of an electronic device according to a status of a battery, the method comprising the following steps:
a) detecting remaining capacity of a battery installed on an electronic device; and
b) controlling screen brightness of the electronic device according to the remaining capacity of the battery.

2. The method of claim 1 further comprising detecting type of power supply of the electronic device.

3. The method of claim 1 further comprising generating remaining utilization time of the battery according to the remaining capacity of the battery wherein step (b) is controlling the screen brightness of the electronic device according to the remaining utilization time of the battery.

4. The method of claim 1 wherein step (a) is a basic input/output system (BIOS) detecting the remaining capacity of the battery installed on the electronic device.

5. The method of claim 1 further comprising generating a screen brightness value according to the remaining capacity of the battery wherein step (b) is controlling the screen brightness of the electronic device according to the screen brightness value.
